(19) United States
(12) Patent Application Publication
(10) Pub. No.: US 2019/0018545 A1
(43) Pub. Date: Jan. 17, 2019

(54) SYSTEM AND METHOD FOR RAPID FINANCIAL APP PROTOTYPING

(71) Applicant: International Business Machines Corporation, Armonk, NY (US)

(72) Inventors: FELIX KWIZERA, NAIROBI (KE); ERIC MIBUARI, NAIROBI (KE); PURITY MUGAMBI, NAIROBI (KE); VIOLETTE OGEGA, NAIROBI (KE); SKYLER SPEAKMAN, NAIROBI (KE); ISAAC WAMBUGU, NAIROBI (KE)

(21) Appl. No.: 15/648,873

(22) Filed: Jul. 13, 2017

(51) Int. Cl. G06F 3/0481; G06Q 30/02

(52) U.S. Cl. CPC G06F 3/0481; G06F 17/211; G06Q 30/0208

(57) ABSTRACT

The disclosure provides systems and methods for rapid prototyping of GUIs based on data files. The GUIs are suitable for use by customers of a service provider such as a financial service provider, and may be designed for any platform such as common mobile platforms. The systems and methods provide a convenient method for testing new GUIs for rollout and modification of products by the provider.

### BACKGROUND

In embodiments, the technical field of the invention is methods and systems for automatically generating user interfaces.

Mobile devices are now common in everyday life for much of the world's population. All modern mobile devices employ operating software, and some devices are flexible in their ability to generate a graphical user interface (GUI) based on software that is factory-installed and/or downloaded by a user. The GUI provides an important interface with the user of the mobile device.

One sector that frequently updates GUIs is the financial sector. Updates to GUIs for financial applications on mobile and non-mobile devices may result, for example, when a financial services provider such as a bank or investment company decides to offer a new financial product or to modify an existing financial product.

Although financial service providers are abundant across Africa, approximately two thirds of the population in sub Saharan Africa do not have access to financial services. Furthermore, only about 16% of this population have formal savings. Efforts to increase financial inclusion among this population need to consider their preconceived attitudes towards financial services and products.

Financial institutions need to be able to understand their users so as to tailor-make investment products that are flexible to the investment strategies and capabilities of the youth. They need to be able to determine if their financial products/services will be well received in the market before putting more time and money into them so that if they are not accepted they can quickly redefine and retest or if they are accepted, they deploy them as fast as possible for the products to be consumed. For at least these reasons it is important for the financial and other sectors to have methods and systems that can rapidly generate a GUI based on a variety of types and sources of input.

### SUMMARY

In an aspect, then, is a method for the rapid design of a user interface within a computer system including the steps of: receiving, by a user device, a data file comprising a root object, the root object comprising contents selected from a view object, a data object, an action object, and an endpoint object; parsing the data file to identify the root object and the contents of the root object; automatically generating a graphical user interface (GUI) based on the root object and the contents of the root object, the GUI comprising components selected from a view region generated from the view object, a data region generated from the data object, and an action region generated from the action object and comprising a link to a backend application programming interface (API) defined by the endpoint object; and automatically altering a display on the user device to display the generated GUI. In embodiments:

the user device is a mobile device selected from a mobile phone and a tablet;

the displaying comprises selecting properties of the GUI based on physical properties of the device;

the displaying comprises selecting properties of the GUI based on physical properties of the device such as button size, font, color, etc.;

the data file is formatted as any data serialization language that represents data in key value pairs;

the data file is formatted as any data serialization language that represents data in key value pairs such as a JavaScript Object Notation (JSON) array, YAML, BSON, or eXtensible Markup Language (XML) data file;

the backend API is an application running on a server, wherein the server is accessible via a distributed network;

the data file is received via a distributed network.

the action region comprises a data entry field configured to accept user data from a user, and wherein the GUI is configured to transmit the user data to the backend API via distributed network;

further comprising receiving input from a user via the GUI, and communicating the input to a remote server via a distributed network;

further comprising receiving input from a user via the GUI, communicating the input to a remote server via a distributed network, modifying the data file based on the input to form a modified data file, transmitting the modified data file to the user device, and automatically regenerating the GUI based on the modified data file;

further comprising populating the GUI with graphical symbols selected from a library of graphical symbols and specified in the data file;

the data file comprises a plurality of root objects, each root object independently comprising contents selected from a view object, a data object, an action object, and an endpoint object; and

the data file comprises a plurality of root objects, each root object independently comprising contents selected from a view object, a data object, an action object, and an endpoint object, wherein the method comprises parsing the data file to identify each of the plurality of root objects and the contents of the root objects, and wherein the GUI is automatically generated based on the plurality of root objects and the contents of the plurality of root objects.

In an aspect is a system for the rapid design of a user interface comprising: a processor; a memory coupled to the processor, the memory configured to store program instructions for instructing the processor to carry out the method as above. In embodiments:

the system comprises more than one processor and/or more than one memory component;

further comprising an interface module configured to aggregate user data and usage data obtained from the generated GUI, format the aggregated user data and usage data, and transmit the formatted aggregated user data and usage data to a user; and

further comprising an interface module configured to aggregate user data and usage data obtained from the generated GUI, format the aggregated user data and usage data, e.g., for analysis by a programmer to prepare a final GUI, and transmit the formatted aggregated user data and usage data to a provider, e.g., a bank dashboard or other provider.

In an aspect is a method for generating and testing a user interface, the method comprising: generating a graphical user interface (GUI) from a data file, the data file comprising a root object, the root object comprising contents selected from a view object, a data object, an action object, and an endpoint object; displaying the GUI on a user device; accepting user data input to the user device via the GUI; generating and transmitting a message via a distributed network, the message configured to be received by a server and used by the server to generate a modified data file, the modified data file suitable for generating a modified GUI. In embodiments:

further comprising receiving, by a server, the message, using the message to generate a modified data file, and transmitting the modified data file to the user device via a distributed network;

the GUI comprises a view region generated from the view object, a data region generated from the data object, and an action region generated from the action object and comprising a link to a backend application programming interface (API) defined by the endpoint object;

the data file is formatted as a JavaScript Object Notation (JSON) array or eXtensible Markup Language (XML) data file, and wherein the GUI comprises a view region generated from the view object, and wherein the GUI automatically formats the view region based on physical characteristics of the user device; and

the action object defines a link to an application on a remote server, the link configured to transmit user data received by the GUI to the remote server.

In an aspect is a system for the rapid design of a user interface comprising: a processor; a memory coupled to the processor, the memory configured to store program instructions for instructing the processor to carry out the method as above.

These and other aspects of the invention will be apparent to one of skill in the art from the description provided herein, including the examples and claims.

### BRIEF DESCRIPTION OF THE DRAWINGS

FIG. 1 provides a flow diagram for a data file and production of a new GUI according to embodiments described herein.

FIG. 2 provides a flow diagram for a GUI Converter according to embodiments described herein.

FIGS. 3A-3D, collectively FIG. 3, provide a schematic representation of the development of a new GUI and certain components thereof according to embodiments described herein.

FIG. 4 provides a flow diagram and interaction between the user and provider, via the backend, according to embodiments described herein.

FIG. 5 provides further architecture information for a GUI Converter interaction with a provider and user according to embodiments described herein.

FIG. 6 provides an example of a JSON file suitable as a data file.

### DETAILED DESCRIPTION

The systems and methods described herein are designed to allow financial institutions and other institutions (alternatively herein, “providers”) to incentivize their users in order to maximize participation in the financial and other products offered by the institutions. The systems/methods allow for rapid prototyping of GUIs for proposed products, which enable the provider to test and determine effectiveness of the GUI prior to roll-out of the actual product. Further incentives for users and providers to use the described systems and methods include: discount on the actual product and/or GUI when launched; membership that allows privileged services at the institution for participation (e.g.: priority queues, walk-in appointments); frequent users are considered for paid product consultant opportunities after testing a large number of GUIs; and the offering of lotteries and raffles with in-cash or in-kind rewards for users.

In an aspect, then, is a method for the rapid design of a user interface within a computer system including the steps of: receiving, by a user device, a data file comprising a root object, the root object comprising contents selected from a view object, a data object, an action object, and an endpoint object; parsing the data file to identify the root object and the contents of the root object; automatically generating a graphical user interface (GUI) based on the root object and the contents of the root object, the GUI comprising components selected from a view region generated from the view object, a data region generated from the data object, and an action region generated from the action object and comprising a link to a backend application programming interface (API) defined by the endpoint object; automatically altering a display on the user device to display the generated GUI.

In an aspect is a method for generating and testing a user interface, the method comprising: generating a graphical user interface (GUI) from a data file, the data file comprising a root object, the root object comprising contents selected from a view object, a data object, an action object, and an endpoint object; displaying the GUI on a user device; accepting user data input to the user device via the GUI; generating and transmitting a message via a distributed network, the message configured to be received by a server and used by the server to generate a modified data file, the modified data file suitable for generating a modified GUI.

In an aspect is a method for generating and testing a user interface, the method comprising: receiving, by a server via a distributed network, a message from a user device, the message configured to cause the server to generate a modified data file; generating a modified data file based on the message; and transmitting the modified data file via the distributed network for reception by the user device, wherein the modified data file is suitable for causing the user device to generate a modified GUI and comprises a root object, wherein the root object comprises contents selected from a view object, a data object, an action object, and an endpoint object.

Throughout this specification, systems and methods are provided for generating new GUIs. A “new” GUI, as the term is used herein and unless specified otherwise, includes a modified version of a previously existing GUI.

The GUIs generated with the methods and systems herein are suitable for a user device. In embodiments, the user device is a mobile device. Examples of mobile devices include mobile phones, tablets, Personal Digital Assistants, and the like, as well as devices that are combinations thereof or hybrids thereof. In addition to such mobile devices (or in the alternative) the GUIs may further be suitable for netbooks, notebooks (i.e., laptops), and desktop (i.e., non-mobile) computers. The user device may be operating with any known or later developed operating system, such as iOS, Android, etc., and the systems herein will be readily modified to be compatible with such various operating systems.

The user device has an output component (or multiple such components) suitable for using a GUI developed by the systems/methods herein. Examples of such output components include display screens, including touchscreens and non-touch-sensitive screens, projection devices, and the like. In embodiments the output component is a display screen. Certain physical aspects of a display screen will vary such as screen size, colour capabilities, touch sensitivity, and the like, some of which aspects are determined by the identity (model, features, etc.) of the user device. The systems and methods herein can be readily configured to automatically account for such varying physical features, particularly such that the generated GUIs are capable of operating on a plurality (most or all) of different user devices. It will further be appreciated that these and other physical aspects of the output component of the user device may affect various aspects/properties (e.g., visual and software aspects) of a generated GUI—e.g., button size, button placement, font size, font colour, background colour, and the like. Such properties may be automatically configured by the methods herein based on identification of the user device and platform.

The methods herein involve generating a data file. The data file is formatted as any data serialization language that represents data in key value pairs. Examples of such file types include JavaScript Object Notation (JSON) array, YAML, Binary JSON (BSON), or eXtensible Markup Language (XML) data file, or any similar or equivalent data file now known or later developed. For example, the data file is a JSON file, which represents data in key value pairs. The data file will contain data (described in more detail herein) as well as any other information/components necessary or required by the standard formatting of the specific data file type.

The data contained in the data file comprises key value pairs that instruct the user device to generate a new GUI. The key value pairs are determined, for example, by the system in response to input from one or more users—such input may include feedback in response to the user's interactions with a test GUI. Alternatively or in addition, the key value pairs are determined by the system after receiving parameters (from a user or from a non-user such as a systems manager, developer, or the like) intended for creation of the data file. Alternatively or in addition, the key value pairs are specified by a developer or other individual with data-entry capabilities and the capability to prepare the data file. In embodiments, the data file is prepared by the provider in order to test out new GUIs and/or new features in a GUI. This allows a dynamic and rapid deployment of new (prototype) applications without having to create a new application from scratch.

In embodiments, the data file may contain a variety of different key value pairs. In embodiments, certain key value pairs in the data file are present and selected to create desired objects in a GUI. For example, an object in a GUI created by a key value pair may be an action object, or a data collection object, or a data delivery object. An example of a data collection object is a profile object, where a user can create or update the user's profile. Profile data can then be stored on the user device and/or on the server, and can be used to determine a variety of variables such as the products offered to the user, specific details about the products offered to the user (based on location, income level, etc.), and other variables. Another example of a data collection object is a survey object. A survey object may be used by a provider, for example, to gather data and preferences about users. An example of a data delivery object is a “new product” object that allows users to learn more about new products offered by the provider. Examples of action objects are given herein for a system designed for the financial sector, although the system is not intended to be limited to that sector. Thus examples of action objects are those that allow a user to: buy and sell forex; buy and sell securities; apply for loans; open an account; add a dependent; and the like. In embodiments, the action object defines the interactions a user can do with the product (i.e.: buy, sell, add dependent, etc.). In embodiments the action object defines a link to an application on a remote server, the link configured to transmit user data received by the GUI to the remote server.

A further key value pair that may be present is for an endpoint object. An endpoint object is used to define (and link the GUI to) a backend API that enables an action by the system. The key value pairs may be organized in the data file in a hierarchal fashion, such that objects in the GUI are appropriately organized as desired. For example, nesting key value pairs can create objects within objects in the GUI.

In an embodiment, a root object in a data file is converted, by the interface module, to a product view in a GUI. Throughout this disclosure, root objects create product views, and the latter may be alternatively referred to as “menu items.” Furthermore a product data object is used by the interface module to create a filter in the GUI—e.g., to filter the target audience as well as giving a brief description of the product. An action object or a plurality of action objects are used to define (in the GUI) the actions that are available to a user. Each action object contains a views object and an endpoint object; the views object defines the required fields for each action and which elements are used to display the required elements. The endpoints object defines the backend API that the action hits. Thus, the endpoint allows you to have actions—e.g., applying for a life insurance policy, you have certain actions—applying, listing references, etc., and the endpoint is on a backend system.

In an embodiment, the data file comprises a plurality of root objects, each root object independently comprising contents selected from a view object, a data object, an action object, and an endpoint object. A plurality of each of these objects may be independently present where desired.

The data file is stored on the server and communicated to one or more user devices from the server via a distributed network. For example, the server may transmit the data file to a user device, the user device employing hardware and an application (software) that receives the data file and processes the data file according to this disclosure. Processing of the data file by the user device causes the user device to generate a new GUI based on the data contained in the data file. On the server, a backend API remains available for further communications with the user device, as described in more detail herein. Throughout this disclosure, the server may be referred to as the “backend” of the systems described. On the user side, a user application (“app”) allows the user to interact with the system, and may be viable for any suitable platform, including iOS, Android, a USSD application, a Microsoft application, or the like. For example, the user app may allow the user to initiate generation of a GUI once a data file is received, or may be used by the user to fetch a data file from the server. Either or both of these functions may also be automated such that, for example, a data file is automatically pushed to a user device and/or automatically used by the user device to generate a GUI.

When a user device receives a data file from the server or another source, the user device stores the data file in memory and then processes the data file using an interface module (also referred to herein as a GUI Converter). Processing the data file may involve, for example, parsing the data file to identify root objects and other objects. The interface module has two functions: (1) to generate a GUI from a data file; and (2) manage the interaction and interface between a simulated environment and a real world environment. The simulated environment serves as the test bed for new products. The simulated environment can be implemented as a view in a mobile application, but modified such that user actions are not “real.” For example, the simulated environment in a financial application can use virtual money (an arbitrary amount or an amount related to the amount of real money held by the user in the real environment) rather than real money. In contrast, the real world environment is where real products are consumed by the users, even if on an experimental basis. Thus, in a real world environment for a financial product application, the money controlled by the application is real and belongs to the customer.

In embodiments, the GUI comprises a view region generated from the view object, a data region generated from the data object, and an action region generated from the action object and comprising a link to a backend application programming interface (API) defined by the endpoint object. Formatting of the GUI can be accomplished automatically. For example, in embodiments the GUI comprises a view region generated from the view object, and wherein the GUI automatically formats the view region based on physical characteristics of the user device. In further embodiments the GUI may provide the user to manually modify viewing aspects of the GUI (e.g., through a settings menu).

In embodiments the data file comprises a plurality of root objects, each root object independently comprising contents selected from a view object, a data object, an action object, and an endpoint object. The GUI converter comprises parsing the data file to identify each of the plurality of root objects and the contents of the root objects, and the GUI is automatically generated based on the plurality of root objects and the contents of the plurality of root objects.

In embodiments the GUI provides a channel configured to allow a user to input data. For example, an action region may comprise a data entry field configured to accept user data from a user. In such cases the GUI will further be configured to transmit the user data to the backend API via distributed network (as well as, optionally, to store such data prior to transmission). Furthermore the GUI may provide a channel configured to accept user input—such input including data but also including user feedback on specific aspects of the GUI such as usability (user friendliness, logical flow, etc.), aesthetic attractiveness, and the like. All such input may be aggregated and transmitted to the server or transmitted directly in real time to the server. Furthermore the GUI may automatically gather information about the user's activities and interactions with the GUI in order to improve subsequent versions of the GUI—e.g., the number of times a user starts over or retraces steps while using a specific menu option, the amount of time that elapses while a user is at any particular location within the GUI, whether certain menu items are selected and used more frequently by a user compared with other menu items, and the like. These data may be aggregated and transmitted to the server (or transmitted directly in real time) and used by the server, as described herein, to create new and improved versions of the data file used to create the GUI.

In embodiments, the interface module provides a level abstraction and performs the following functions: receives a data file corresponding to a product from a provider (e.g., via a provider dashboard) and sends the data file to either the simulated environment or the real world environment depending on the provider's selection; receives data collected in the simulated environment and forwards it to the provider; moves a product data file from the simulated environment to the real world environment if the product is deemed successful by the provider; receives requests from the real world environment (e.g., in financial products, buy investment, sell investment, top up balance, etc.) and forwards them to the provider; and receives responses from the provider and forwards them to the real world environment.

As mentioned herein, the new GUI provides one or more channels for a user to input user feedback on their experience of the GUI. Alternatively and in addition the GUI may automatically obtain information on the user's interactions with the GUI. These data are transmitted to the server in the form of a message, and the server may use the data to create a new data file (also referred to herein as a “modified data file”, although it will be appreciated that each new data file creates a new GUI). The new data file is configured to be used by an interface module (i.e., GUI converter) to create a new GUI. Accordingly the new data file may be communicated to a user device. Each of the abovementioned steps may be automatically executed by the server and/or user device. In embodiments, the interface module is configured to aggregate user data and usage data (e.g., from a single user), optionally format the user data and usage data, and transmit the same to a server and/or provider dashboard. The server and/or provider dashboard is configured to receive and aggregate data from a plurality of users each testing a GUI generated by a common data file transmitted to different user devices, and analyse such data (e.g., to generate a new data file).

The GUI created by the processing of the data file may further be populated with graphical symbols selected from a library of graphical symbols and specified in the data file. Such populating may be carried out automatically by the GUI converter. The GUI may further contain a feedback channel in order for the user to provide feedback on the layout of the GUI, including the use of graphical symbols.

Throughout this specification are described various methods, and references may be made to the systems that carry out such methods. For example, in embodiments there is provided a system for the rapid design of a user interface comprising: a processor; a memory coupled to the processor, the memory configured to store program instructions for instructing the processor to carry out the method. The systems described or referenced herein will comprise any components that are necessary for such system to be operational. Some such components may not be specifically mentioned herein for the sake of brevity, but in such cases the components are those that are well known in the art and would be obvious to one of ordinary skill in the art. Examples of such include power supplies, co-processors, I/O components, software and firmware necessary to operate various physical components, and the like.

Various embodiments of the invention are described more fully hereinafter with reference to the accompanying drawings. The invention herein may be embodied in many different forms and should not be construed as limited to the embodiments set forth in the drawings; rather, these embodiments are provided to provide further illustrative non-limiting examples. Arrowheads in the figures are provided merely as examples of directions for the flow of data but are not exhaustive and are not meant to be limiting—i.e., data may flow (where appropriate) in directions that are not shown by arrowheads in the figures. Similar numbers in different figures are meant to refer to similar components.

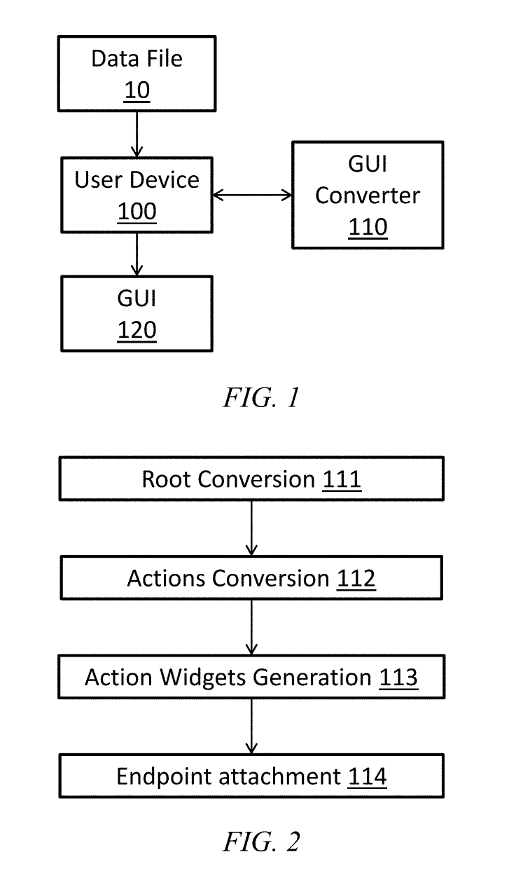

With reference to FIG. 1, there is shown a basic flow chart for producing a new GUI according to an embodiment of the invention. Data file 10 is communicated to User Device 100. User device 100 comprises and runs the module GUI Converter 110, which generates GUI 120 for display/output by User Device 100.

With reference to FIG. 2, there is shown a schematic used by a GUI converter in preparing a new GUI according to an embodiment of the invention. In the schematic, Root Conversion 111 identifies product and product data, typically as data pairs in a data file (not shown). Actions Conversion 112 converts product actions to views and/or lists. The module Action Widget Generation 113 converts template action widgets to actual platform widgets for use by the GUI. Furthermore, the module Endpoint Attachment 114 attaches endpoints to corresponding action widgets.

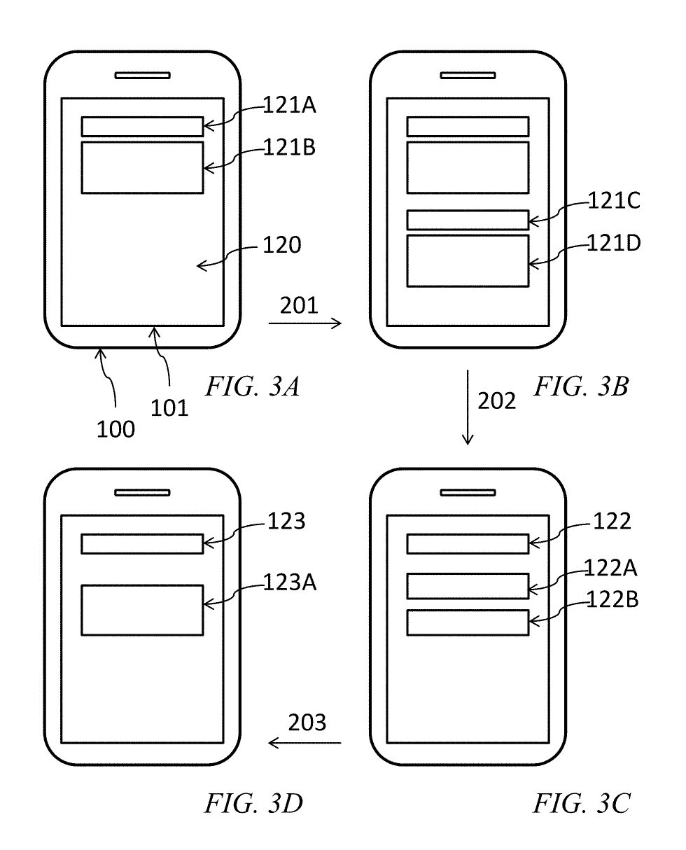

With reference to FIG. 3, there is shown a stylized evolution of a GUI after processing a data file according to an embodiment of the invention. Throughout FIGS. 3A, 3B, 3C, and 3D, Device 100 contains touchscreen 101, which displays GUI 120 as the GUI is modified in response to processing the data file. In FIG. 3A, GUI 120 comprises one button 121A and one information field 121B—the latter containing information explaining the former (e.g., button 121A may be labeled “Stocks” and information field 121B contains information pertaining to the actions that can be taken when the user touches the button). To obtain the image in FIG. 3B, device 100 processes (201) a data file (not labeled or shown). In FIG. 3B, then, new button 121C and new information field 121D appear in the GUI (e.g., button 121C may be labeled “Forex” and information field 121D provides information about the actions that can be taken when the user touches that button). If the user, for example, presses (202) button 121C the user is taken to the image in FIG. 3C, which contains label 122 and option buttons 122A and 122B (for example, label 122 may read “Forex” and the option buttons may give the user the option to specify whether to “buy” or “sell”). If the user presses (203) one of the option buttons, the user is taken to the image in FIG. 3D, which provides label 123 and data entry field 123A (e.g., label 123 may read “Buy Forex” and data entry field 123A may allow the user to enter an amount for buying).

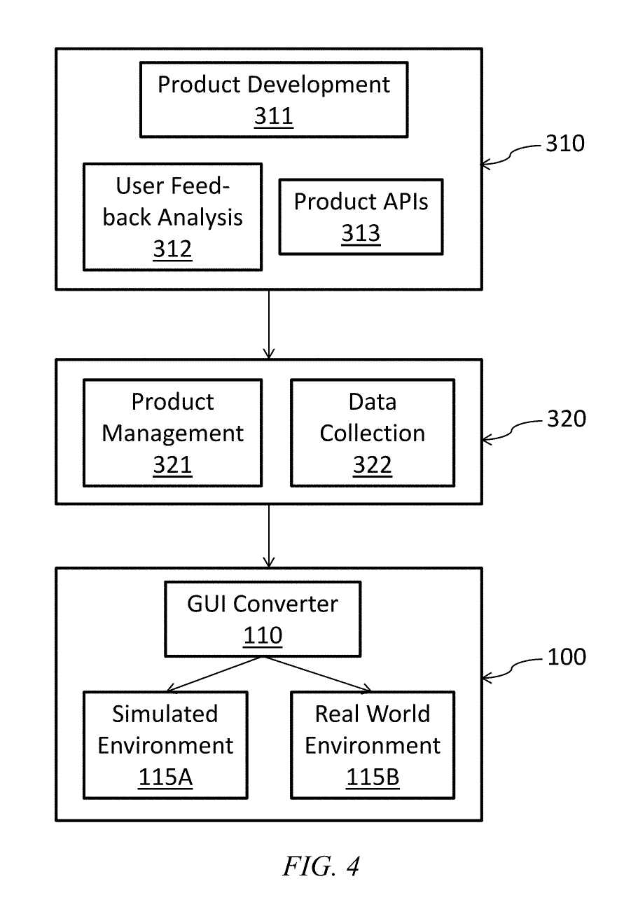

With reference to FIG. 4, there is shown a schematic representing the process of an interaction between a provider and a user. On the provider side, provider dashboard 310 allows the provider to carry out Product Development 311, carry out User Feedback Analysis 312, and produce Product APIs 313. Product development 311 may involve, for example, defining a product target demographic, or defining a product characteristic(s). User Feedback Analysis 312 may involve, for example, displaying real-time product uptake and interest, and/or suggesting modifications for the product based on past experiences. Generating the Product APIs 313 may involve, e.g., processing simulated and real-world environment transactions, or handling product business rules. Backend service 320 includes Product Management 321 and Data Collection 322. Product management may involve, e.g., deploying a product to a simulated environment, deploying a product to a real world environment, moving a product from one environment to another (real world to simulated or vice versa), and/or forwarding API calls to the provider. Data collection may involve collecting data pertaining to, e.g., simulating product usage, uptake, and interest, real world product usage, and demographics data (i.e., the interest and usage of various demographics) from both simulated and real world environments. Finally, User Device 100 comprises GUI Converter 110, which converts a data file delivered to User Device 100 into either a Simulated Environment 115A or a Real World Environment 115B. Whether to produce a GUI for simulation or the real world may be an instruction provided in the data file, for example.

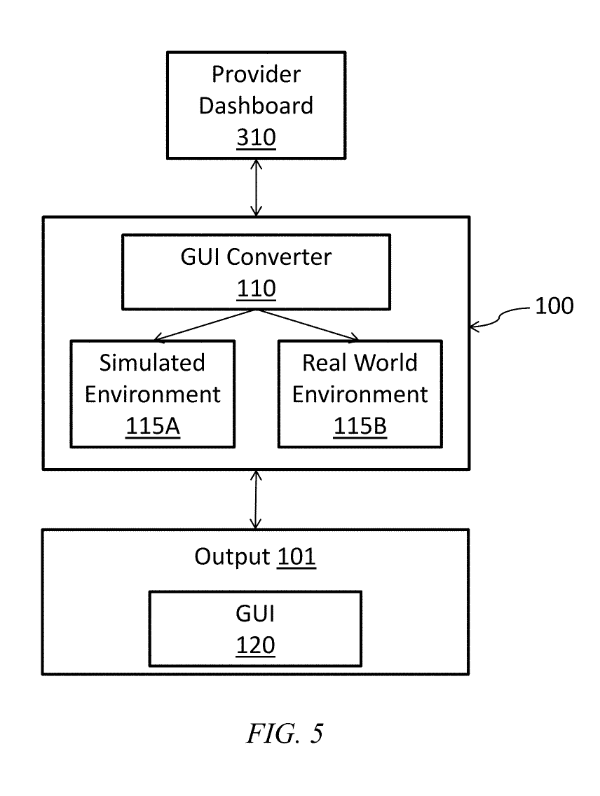

With reference to FIG. 5, there is shown an architecture with a more detailed schematic of the interaction between the provider and user. Thus Provider Dashboard 310 interacts with User Device 100 (via the backend service, not shown). On User Device 100 is run a user application, and the application interacts with an output component 101 (e.g., a touchscreen) that utilizes/displays GUI 120.

Throughout this disclosure, use of the term “server” is meant to include any computer system containing a processor and memory, and capable of containing or accessing computer instructions suitable for instructing the processor to carry out any desired steps. The server may be a traditional server, a desktop computer, a laptop, or in some cases and where appropriate, a tablet or mobile phone. The server may also be a virtual server, wherein the processor and memory are cloud-based.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

### EXAMPLES

### Example 1

In an example, two scenarios were considered: (1) a financial institution already has a web application or mobile application; and (2) a business that provides a web or mobile application platform on which financial institutions can advertise their products. The solution provided according to this disclosure provided a real environment where users see current products and a simulated environment where users see products being tested. If a test product succeeds, making the GUI for that real product involves moving from the simulated environment to the real environment. These different environments are two different views or modules within one application.

Scenario one: users can access to view and buy into the institution's financial products offerings (e.g.: a mobile application that provides investment portfolio management: buying investment options, selling the options, etc.).

Scenario two: the provider supplies the front end with which users interact (e.g., viewing available offerings, buying them) and a back end that financial institutions use to process user requests, defining their products and forwarding them to the front end.

For example, an investment bank wants to roll out a new money market fund product. The bank defines the product in their backend (i.e.: setting the products' characteristics such as a short description of the product, initial sign-up fee, minimum and maximum top-up amounts, interest rate, duration of investment etc.) and then deploy it in the system.

As the product is being tested it is shown in the test products section (i.e., simulated environment). Users get a notification such as a SMS, email or an in-app notification informing them of the new product with its short description. The system then gauges user uptake (Uᵤ) and user interest (Uᵢ). User uptake is defined as how many users signed up after viewing the notification. User interest is a determination for the users who signed up for the product, and is a measure of how interested they are in this product. This is calculated in this example by checking how much of the virtual money in the product was used by the user.

The number of users who viewed the notification is, in this example, defined as Nᵥ and is the total number of people in the system. That is, it is not necessary for a user, after receiving a notification, to elect to see more about the product in order for the user to be counted in the number of users.

A mathematical representation of these two metrics would be:

User Uptake(Uᵤ)=Number of Sign Ups(Nₛ)/Number of Views(Nᵥ)

User Interest(Uᵢ)=The Sum over the number n of users of: (Amount invested(Aₙ)/User's Available Balance(Bₙ))/Number of Users (n)

The simulated environment serves as the test bed for new products. It can be implemented as a view in a mobile application. Here users use virtual money that is a reflection of their current balance (i.e.: if a user has USD 30 in the real world, they would have USD 30 in the simulated environment, however if they use this amount in the simulated environment, their real-world balance is not affected).

In the case where a user is interested in a product but does not have the funds to invest in a product, the user is still counted as an interested user and they may be asked to give a percentage of how much of their money they would have used if they had sufficient funds.

### Example 2

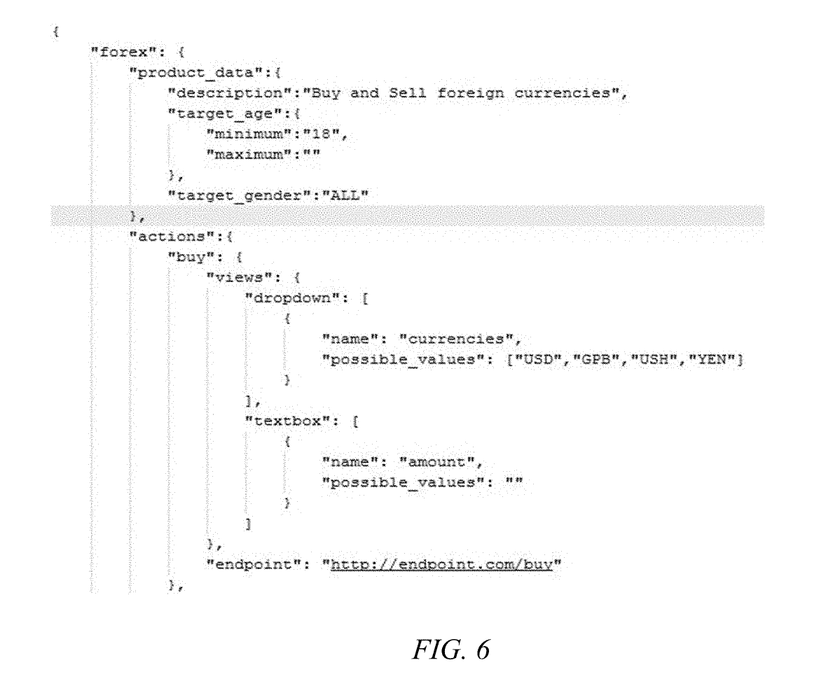

An example of a JSON file suitable as a data file is provided in FIG. 6.

The JSON shown in FIG. 6 can be processed by the systems described herein in order to develop a new interactive GUI having, for example, a “Buy and Sell foreign currencies” button, etc.

1.-12. (canceled)

13. A system for the rapid design of a user interface comprising:
a processor;
a memory coupled to the processor, the memory configured to store program instructions for instructing the processor to carry out a method for the rapid design of a user interface within a computer system including the steps of:
receiving, by a user device, a data file comprising a root object, the root object comprising contents selected from a view object, a data object, an action object, and an endpoint object;
parsing the data file to identify the root object and the contents of the root object;
automatically generating a graphical user interface (GUI) based on the root object and the contents of the root object, the GUI comprising components selected from a view region generated from the view object, a data region generated from the data object, and an action region generated from the action object and comprising a link to a backend application programming interface (API) defined by the endpoint object;
automatically altering a display on the user device to display the generated GUI.

14. The system of claim 13, further comprising an interface module configured to aggregate user data and usage data obtained from the generated GUI, format the aggregated user data and usage data, and transmit the formatted aggregated user data and usage data to a provider.

15.-19. (canceled)

20. A system for the rapid design of a user interface comprising:
a processor;
a memory coupled to the processor, the memory configured to store program instructions for instructing the processor to carry out a method for generating and testing a user interface, the method comprising:
generating a graphical user interface (GUI) from a data file, the data file comprising a root object, the root object comprising contents selected from a view object, a data object, an action object, and an endpoint object;
displaying the GUI on a user device;
accepting user data input to the user device via the GUI;
generating and transmitting a message via a distributed network, the message configured to be received by a server and used by the server to generate a modified data file, the modified data file suitable for generating a modified GUI.
